(19) United States
(12) Patent Application Publication
(10) Pub. No.: US 2026/0305852 A1
(43) Pub. Date: Oct. 8, 2026

(54) LAYERED SIPPY CUPS

(71) Applicant: WOW GEAR LLC, Santa Barbara, CA (US)

(72) Inventor: David Tognarelli, Santa Barbara, CA (US)

(21) Appl. No.: 19/637,825

(22) Filed: Apr. 2, 2026

Related U.S. Application Data
(60) Provisional application No. 63/783,122, filed on Apr. 3, 2025.

(51) Int. Cl. A47G 19/22; B29D 22/00; B29K 67/00; B29K 83/00; B65D 25/14; B65D 25/56; B65D 47/20

(52) U.S. Cl. CPC A47G 19/2272; B29D 22/003; B65D 25/14; B65D 25/56; B65D 47/2031; A47G 2400/10; B29K 2067/006; B29K 2083/00

(57) ABSTRACT

An all-around drinking edge sippy cup includes a body to store a liquid. The body can have an inner surface and a rigid outer shell. The inner surface includes silicone. A collar is coupled with the body and includes a hard plastic base and a silicone layer over the hard plastic base. The silicone layer of the collar can cover portions of the drinking cup that contact the liquid and the user. A valve is sealingly disposed within the collar and includes silicone. The valve can have an upper surface that contacts the user. The valve is configured to separate from the collar to dispense liquid in response to pressure from the user's mouth on the upper surface. The liquid is dispensed such that it contacts only silicone along its flow path from the body through the collar.

### CROSS-REFERENCE

This application claims priority to U.S. provisional patent application No. 63/783,122, filed on Apr. 3, 2025, the disclosure of which is incorporated by reference herein in its entirety. Any and all applications for which a foreign or domestic priority claim is identified in the Application Data Sheet as filed with the present application are hereby incorporated by reference under 37 CFR 1.57.

### BACKGROUND

### Field

The present disclosure relates to drinking cups that allow a user (e.g., an infant, a toddler, etc.) to drink liquids with reduced spilling (and thus may be referred to herein as “sippy cups”), and in particular to sippy cups having multiple layers and that provide a food-safe and/or plastic-free contact surfaces.

### Certain Related Art

Drinking cups for infants, toddlers, and other users are often designed to permit convenient drinking of liquids while reducing unintended spilling during ordinary handling and use. Such cups are used in a variety of settings and can be expected to withstand repeated filling.

### SUMMARY OF CERTAIN FEATURES

Existing drinking cups fail to provide a user-friendly configuration while being suitable for contact with beverages. A need exists for an improved drinking cup.

One concern relates to suitability of materials that contact the beverage and the associated health concerns. For example, due to the health concerns of potential microplastic, neurotoxin, and/or endocrine interrupter chemicals introduced into manufactured plastic raw materials used in drinking cups, such as sippy cups and/or adult drinking cups, consumers are looking for drinking devices that provide a safe and/or healthy alternative. Drinking cups that include containers having a plastic interior and/or collars that are made of plastic may not be suitable. The liquid that is stored in such cups and/or flows through the collar of such cups are in contact with a plastic surface, which can permit microplastics or other impurities to contaminate the beverage and be consumed by the user. Drinking cups that are plastic free (e.g., at least as to the portion of the cup that contacts the beverage) can provide a solution. In some embodiments, the drinking cups of the present disclosure are configured such that the liquid and/or the user's mouth only contact non-plastic (e.g., silicone) surfaces.

Another concern relates to the time and/or cost that is involved in manufacturing drinking cups. It can be time consuming to bond health-friendly materials such as silicone on a plastic surface of a drinking cup. For example, bonding methods that require additional primer coatings and adhesives to bond a silicone material to a plastic surface can require multiple manufacturing steps, be time consuming, and/or costly. Drinking cups of the present disclosure provide a feasible production cost while using traditional molding processes.

Another concern relates to ease of assembly and use of sippy cups. Sippy cups that use several parts can be difficult to assemble, and/or clean. Advantageously, the drinking cups of the present disclosure are easy to use and assemble, thereby making them more appealing to consumers, more hygienic, and/or less apt for misassembly. In some embodiments, the sippy cups disclosed herein can include only three separate parts (a body, a collar, and a valve) that are coupled together, thereby making the assembly easy for the user.

Another concern relates to durability of sippy cups and their ability to reduce leakage and/or spilling. Sippy cups that do not properly reduce spilling are undesirable and may be unacceptable for users. In some embodiments, the drinking cups of the present disclosure integrate a soft layer silicone with a durable collar core and a hard outer shell. This can provide a health-friendly drinking cup that is durable and reduces (e.g., eliminates) the amount of unintended spilling from tipping, handling, or similar user interaction(s). The cup can be round (e.g., circular, oval, etc.), rectangular, or other shapes.

Drinking cups, such as sippy cups, can utilize a soft silicone valve gasket against a hard rigid plastic drinking edge collar to seal the drinking cup. Various sippy cups (such as a 360° sippy cup, as discussed in more detail below) have a hard (e.g., rigid) collar. The soft silicone valve gasket can compress against the collar when the upper lip of a user applies a downward force on the silicone valve gasket. If the collar deforms, the sippy cup can leak. Advantageously, the drinking cups of the present disclosure have an inner skeleton for support to reduce or avoid such leakage. A hard plastic (e.g., polypropylene, polycarbonate, Polybutylene terephthalate (PBT), or other similar materials) can be used for the skeleton of the collar in combination with a soft silicone layer for the valve and other liquid-contacting surfaces, thereby providing a hard skeleton while utilizing a soft silicone material. When in use, the liquid contacts only non-plastic (e.g., silicone) material and/or no part of the mouth or liquid comes in contact with a hard plastic material. For example, the liquid does not contact the inner skeleton.

Drinking cups, such as sippy cups, can utilize a soft silicone cup to hold the liquid. However, such designs are not user-friendly and can be disadvantages. For example, such designs can provide insufficient support and/or rigidity. If a child squeezes the cup, the deformation of the cup can push the liquid contained therein to be forced outward, causing unintended dispensing and spillage. Advantageously, the drinking cup of the present disclosure can include a rigid shell while having a soft silicone interior, thereby reducing the risk of unintended spillage from deformation of the cup body. In various embodiments, the cup body is configured to inhibit or prevent collapse even if the user squeezes the body, as some children are prone to do. For example, the cup does not crumple or fold in on itself under the grip force typically applied by a human hand holding the circumferential sides of the cup.

The technology described herein relates to a beverage cup, such as a 360° sippy cup. The cup includes a body configured to receive a beverage or other liquid. The body includes an inner surface and an outer shell. The outer shell can be rigid plastic or metal. The inner surface includes a non-plastic material, such as silicone. A collar is removably or permanently coupled to the body. The collar can have a first user-contact portion, such as a portion to receive a user's lower lip. The collar includes a base and a non-plastic (e.g., silicone) layer over the base. The base can be rigid plastic or metal. The non-plastic layer covers an inside of the collar, such as a portion of the collar that would otherwise contact the liquid during dispensation. The non-plastic layer can wrap around an upper lip of the collar and/or extend down an outside of the collar. A valve (e.g., a diaphragm valve) is sealingly connected to and/or disposed within the collar. The valve can comprise silicone. The valve has an upper surface and a lower surface. The upper surface of the valve can have a second user-contact portion, such as a portion to receive the user's upper lip. The valve is configured to move relative to the collar to dispense the liquid in response to pressure from a user's mouth on the upper surface of the valve and/or the collar. The cup is configured such that, while the liquid is retained in the cup and during dispensing of the liquid out of the cup, the liquid contacts only non-plastic (e.g., silicone) material. Further details and variations and implementations of the cup are described below.

In some embodiments, the techniques described herein relate to a sippy cup. The sippy cup can include a body configured to store a liquid. The body can have a shell including an inner silicone layer. A collar can be coupled to the body. The collar can include a rigid core and a silicone layer over the rigid core; and a valve having an upper surface and a lower surface. The valve can be connected to the collar. The valve can have a lip configured to move between a first position and a second position in response to pressure from a user's mouth on the lip. In the first position the lip can be sealingly engaged with the silicone layer of the collar. In the second position, the lip can be separated from the collar to enable dispensation of the liquid. During dispensation, the liquid contacts only silicone during travel from the body to the user's mouth.

In some embodiments, the techniques described herein relate to a sippy cup, wherein the collar can be threadably coupled to the body.

In some embodiments, the techniques described herein relate to a sippy cup, wherein the core can be made from polybutylene terephthalate hard plastic.

In some embodiments, the techniques described herein relate to a sippy cup, wherein the silicone layer of the collar can be over-molded to the core.

In some embodiments, the techniques described herein relate to a sippy cup, wherein the collar can include one or more passages to enable flow of the liquid out of the body.

In some embodiments, the techniques described herein relate to a sippy cup, wherein the lower surface of the valve can contact the silicone layer of the collar to form a first seal.

In some embodiments, the techniques described herein relate to a sippy cup, wherein the silicone layer of the collar can contact the inner silicone layer of the body to form a second seal.

In some embodiments, the techniques described herein relate to a sippy cup, wherein the liquid can be configured to flow out of the body only through the one or more passages.

In some embodiments, the techniques described herein relate to a sippy cup, wherein the body and the collar can be coaxial such that an axis extending longitudinally through a center of the body aligns with an axis extending longitudinally through a center of the collar.

In some embodiments, the techniques described herein relate to a sippy cup, wherein the valve can include a lower groove configured to engage with a fastening surface of the collar.

In some embodiments, the techniques described herein relate to a sippy cup, wherein the valve can include an upper groove configured to engage with an indentation and an abutment surface of the collar.

In some embodiments, the techniques described herein relate to a sippy cup, wherein the shell of the body can include a window. Certain embodiments do not include a window.

In some embodiments, the techniques described herein relate to a sippy cup, wherein the inner silicone layer of the body can include a clear silicone material, and a volume scale is molded into the clear silicone material to enable a user to see how much of the liquid is left in the body.

In some embodiments, the techniques described herein relate to a method of making a drinking cup. The method can include: obtaining a hard plastic outer shell for a body of the drinking cup; molding a silicone inner surface onto the hard plastic outer shell such that the silicone inner surface lines the body of the drinking cup; obtaining a hard plastic base for a collar of the drinking cup; molding a silicone layer onto portions of the hard plastic base of the collar that contact liquid and a mouth of a user; obtaining a valve that includes a silicone surface; inserting the valve in the collar; and coupling the collar to the body.

In some embodiments, the techniques described herein relate to a method, wherein obtaining the valve can include sealing the valve within the collar such that the silicone surface of the valve directly contacts the silicone layer of the collar.

In some embodiments, the techniques described herein relate to a method, wherein coupling the collar to the body can include sealing the collar and the body such that the silicone layer of the collar directly contacts the silicone inner surface of the body.

In some embodiments, the techniques described herein relate to a method, wherein obtaining the hard plastic base can include injection molding the hard plastic outer shell from polybutylene terephthalate.

In some embodiments, the techniques described herein relate to a method, wherein molding the silicone inner surface onto the hard plastic outer shell can be performed using two-component injection molding process.

In some embodiments, the techniques described herein relate to a method, wherein the method can further include forming a window in the hard plastic outer shell and molding a clear silicone material into the window.

Neither the preceding Summary nor the following Detailed Description and associated drawings purport to limit or define the scope of protection. The scope of protection is defined by the claims.

### BRIEF DESCRIPTION OF THE DRAWINGS

The foregoing and other features of the present disclosure will become more apparent from the following description and appended claims, taken in conjunction with the accompanying drawings. Understanding that these drawings depict only certain embodiments in accordance with the disclosure and are not to be considered limiting of its scope, the disclosure will be described with additional specificity and detail through use of the accompanying drawings. In the following Detailed Description, reference is made to the accompanying drawings, which form a part hereof. In the drawings, similar symbols typically identify similar components, unless context dictates otherwise.

FIG. 1 illustrates a top perspective view of a drinking cup according to one aspect of the present disclosure.

FIG. 2 illustrates a side view thereof, with a valve shown separated from a body for purposes of presentation.

FIG. 3 illustrates another top perspective view of the drinking cup, with the silicone valve separated from the body of the drinking cup.

FIG. 4 illustrates a top view thereof.

FIG. 5 illustrates a partial cross-sectional side view thereof, with a portion of the drinking removed for illustration purposes.

FIG. 6 illustrates a longitudinal cross section thereof.

FIG. 7A illustrates a portion of the longitudinal cross section of the drinking cup in a first position.

FIG. 7B illustrates a portion of the longitudinal cross section of the drinking cup in a second position.

FIG. 8 illustrates a cross section of the drinking cup of FIG. 1 in use according to one aspect of the present disclosure.

FIG. 9A illustrates a side view of a drinking cup according to another aspect of the present disclosure.

FIG. 9B illustrates a longitudinal cross-sectional side view of a drinking cup of FIG. 9A.

FIGS. 10A-10C illustrate a drinking cup collar according to another aspect of the present disclosure.

FIGS. 11A-11C illustrate portions of a drinking cup collar according to another aspect of the present disclosure.

### DETAILED DESCRIPTION OF CERTAIN EMBODIMENTS

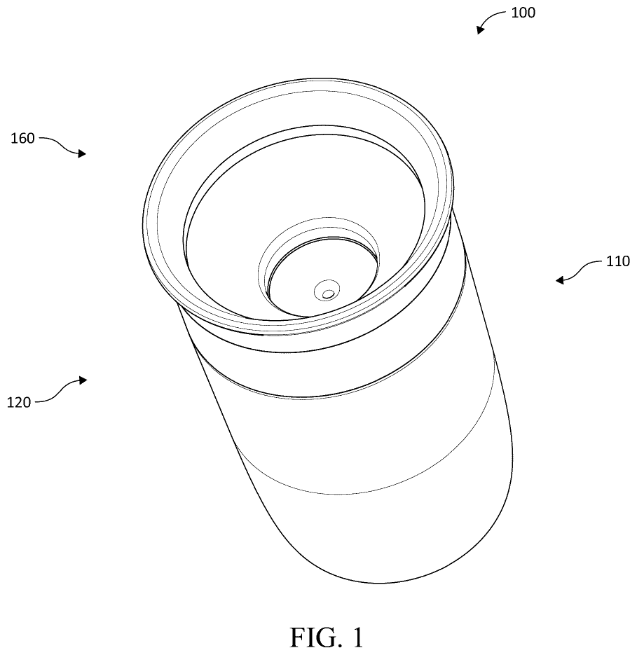

FIG. 1 illustrates a top perspective view of a drinking cup 100 according to one aspect of the present disclosure. The drinking cup 100 can be a sippy cup, such as a 360° sippy cup. A 360° sippy cup permits the user (e.g., a child) to place his or her lips anywhere around the circumference of the cup to access the beverage inside the cup. Further details about 360° sippy cups can be found in U.S. Pat. No. 8,453,870, which is incorporated by reference herein in its entirety. Although some embodiments of the techniques disclosed herein are disclosed with respect to a 360° sippy cup, the present technology may also be applied to other style sippy cups (that do not include an all-around drinking edge), spouted cups, straw cups, baby nipple bottles, and/or open drinking cups. In some embodiments, the cup is a non-sippy cup and/or is suitable for use by adults.

The drinking cup 100 can be manufactured from materials suitable for storing and dispensing beverages and other liquids. For example, portions of the drinking cup 100 can be made of silicone. In addition to having natural antibacterial properties, silicone can include antibacterial properties through special additives (e.g., silver or platinum particles). The drinking cup 100 can be manufactured from materials that are dishwasher safe, thus making it easy for a user to clean the drinking cup 100.

The drinking cup 100 is manufactured to have few separate parts, which can make it easy for parents and/or kids to assemble and/or disassemble the components of the drinking cup 100. For example, as it will be discussed further below, the various components of the drinking cup 100 can mechanically couple to one another to form a sealed drinking cup without a need for a separate sealing gasket. This can make the cup easy to use, assemble, and clean.

In some embodiments, the drinking cup 100 includes a container body 110 (also called a body), a collar 120, and a valve 160. The container body 110, the collar 120, and the valve 160 can mechanically couple to one another to form the drinking cup 100. In one example, the valve 160 is press-fitted in the collar 120 and/or the collar 120 is threadably coupled with the container body 110.

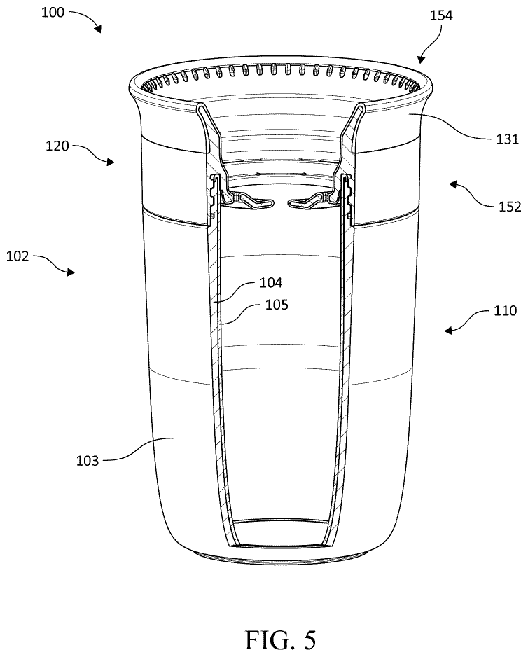

The container body 110 can be manufactured from one or more materials. For example, the exterior of the container body 110 can be manufactured from plastic, such as Polybutylene Terephthalate (PBT), and the interior of the container body 110 (see FIG. 5) can be silicone. Similarly, the collar 120 can be manufactured from one or more materials. For example, the collar 120 can include a combination of plastic (e.g., PBT) and silicone. The valve 160 can be manufactured from different materials. In some implementations, the valve 160 is an elastic silicone valve.

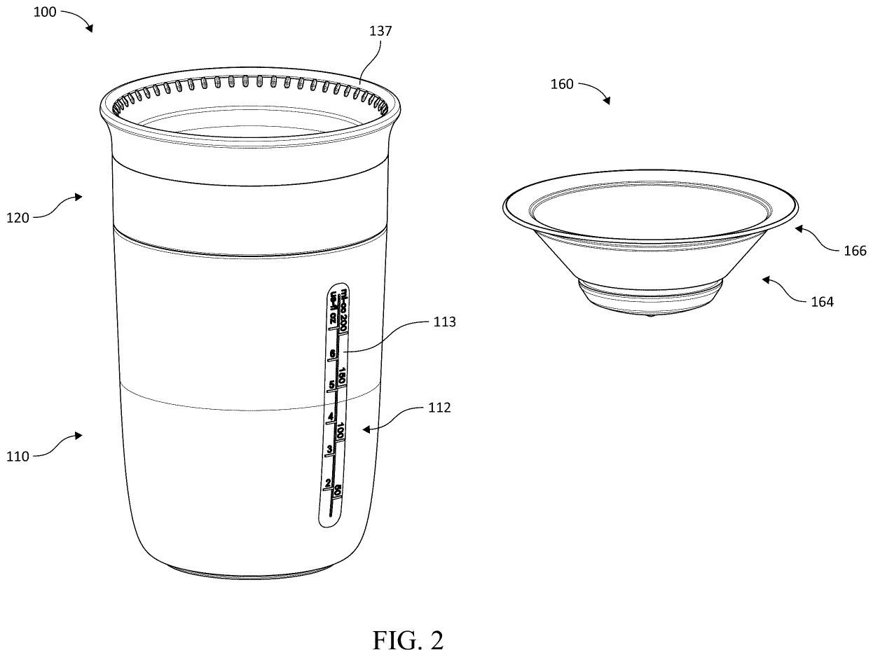

FIG. 2 illustrates a side view of the drinking cup 100, with the valve 160 separated from the container body 110 and collar 120. The body 110 is configured to hold a liquid, such as a beverage. The collar 120 is connected to a top of the body 110, such as with threads. The valve 160 removably couples to the collar 120, as further described below.

In some embodiments, the drinking cup 100 includes a window 112 in the container body 110. The window 112 can be an opening (e.g., a cut out) in the container body 110. In some embodiments, the window 112 can be injection-molded during the cup molding process. In some embodiments, the interior of the container body 110 includes a clear silicone layer that, when molded onto the hard plastic exterior of the container body 110, it allows the clear silicone to flow into the window 112. In some embodiments, such interior clear silicone layer can self-bond with the window 112 to contact points in the window 112, thereby forming a seal (e.g., complete seal). In some embodiments, a volume scale 113 can be molded into the clear silicone material within the formed window, allowing the liquid level within the drinking cup 100 to be viewed and measured. In some embodiments, the window 112 includes a transparent plastic. The inclusion of a window 112 in the drinking cup 100 can add several advantages to the drinking cup 100. For example, unlike a drinking cup that utilizes an opaque plastic, the window 112 enables a user to see the liquid level inside the drinking cup 100. Although FIG. 2 illustrates the drinking cup 100 with a window 112, some embodiments of the drinking cup 100 do not include a window 112.

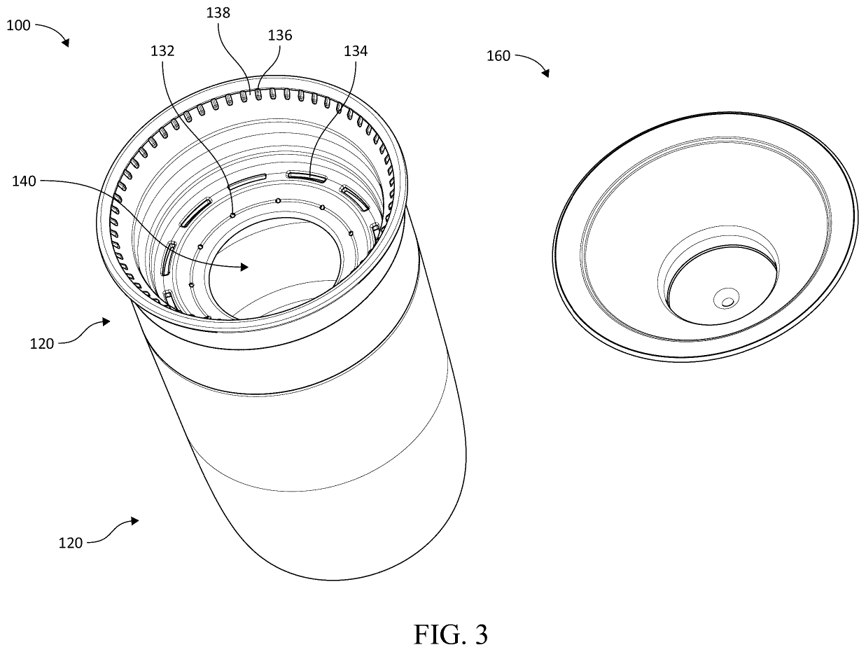

With reference to FIGS. 2 and 3, as previously mentioned, the drinking cup 100 includes the valve 160. The valve 160 can be a soft silicone valve gasket. The valve 160 can be a diaphragm valve, mushroom valve, umbrella valve, or otherwise. The valve 160 can snap into the opening on the inside of the collar 120. For example, the valve 160 can have a bulbous (e.g., mushroom-looking) profile configured to be received in an opening 140 in the collar. The valve 160 can form a seal with a silicone skin of the collar 120. In some embodiments, the valve 160 includes a lower groove 164 that engages with a fastening surface 141 of the collar 120 to form a seal. In some embodiments, the valve 160 has a circumferential leading outer portion or edge, which can be a lip 163. The lip 163 can be configured to form a preloaded compressive seal against a circumferential drinking edge 137 of the collar 120. In some embodiments, the valve 160 includes an upper groove 166. The upper groove 166 can engage with an indentation 136 and an abutment surface 138, as will be discussed in more detail below.

FIG. 3 illustrates another top perspective view of the drinking cup 100, with the valve 160 separated from the body of the drinking cup 100. As discussed above, the drinking cup 100 includes a collar 120. The collar 120 can include one or more features, such as apertures 132 and/or passages 134 that enable flow of liquid from the interior of the container body 110 through collar 120 and/or air to flow into the body 110. The apertures 132 can be drain holes, such as to allow liquid to drain back into the body 110 after use (e.g., after the cup 100 is returned to a generally vertical orientation). One or more indentations 136 along the perimeter of the circumferential drinking edge 137 provide a flow path to enable flow of the liquid for dispensation to the user. The valve 160 can sealingly rest against an abutment surface 138 to inhibit unintended flow of liquid out of the drinking cup 100. In use, a user can place their lips on the upper lip of the cup and the valve and apply suction. When such suction (e.g., suction force from the mouth of the user) displaces part of the valve 160 away from the abutment surface 138, liquid can flow through the indentations 136, and out between the valve 160 and the abutment surface 138. The valve can include an air hole, which can allow ambient air to flow into the body 110 to prevent the formation of a vacuum in the cup 100. The air hole can be in the radial center of the valve 160.

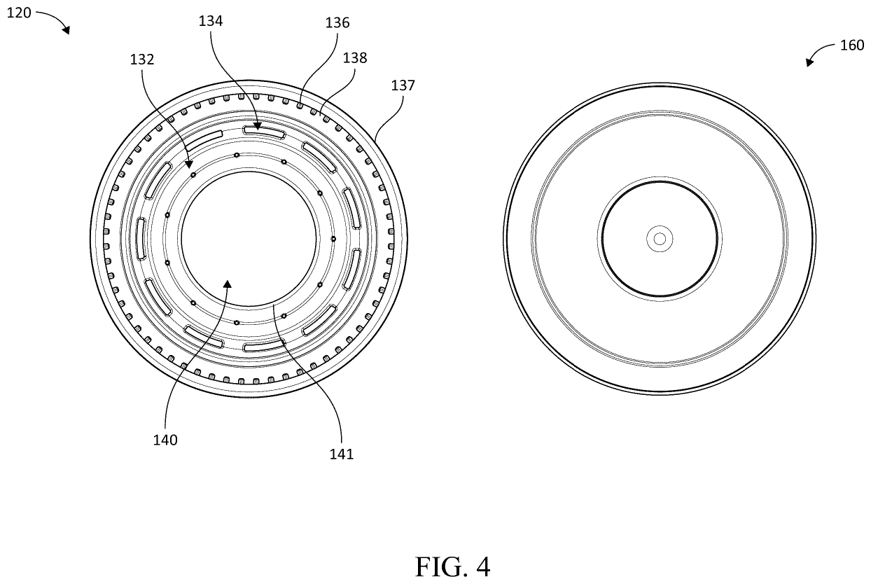

FIG. 4 illustrates the top view of the drinking cup 100, including the top view of the valve 160 separated from the drinking cup 100. The opening 140 can be seen positioned centrally in the drinking cup 100. In some embodiments, the container body 110 and the collar 120 can be coaxial such that an axis extending longitudinally through the center of the container body 110 aligns with an axis extending longitudinally through the center of the collar 120. Also illustrated in FIG. 4 is the fastening surface 141, which can be positioned along the perimeter of the opening 140. Various features of the collar 120, such as the aperture 132, the passage 134, indentation 136, circumferential drinking edge 137, and the abutment surface 138, can be positioned radially outward from the center of the collar 120.

FIG. 5 illustrates a side cross-sectional view of some components of the drinking cup 100, with a portion of the container body 110 removed for illustration purposes. As illustrated, the container body 110 includes a shell 102 (also called a skeleton or a frame). The shell 102 can have an exterior surface 103 and an interior surface 104. In some embodiments, the shell 102 is manufactured from plastic, such as polybutylene terephthalate (PBT), polymethyl methacrylate (PMMA), styrene acrylonitrile, polycarbonate, polypropylene, or otherwise. The plastic can be rigid and/or non-elastic in the conditions of drinking cup usage. For example, the plastic can have a hardness on the Shore D scale of between about 70D and about 90D, such as about: 70D, 75D, 80D, 85D, 90D, or otherwise. In some variants, the shell 102 is metal, such as stainless steel or aluminum. The shell 102 can be an insulator, such as a double-walled insulator (e.g., two distinct layers of plastic or metal or separated by an air gap or a vacuum seal). As shown, inside the shell 102 is a silicone layer 105 (also called a skin). The silicone layer 105 can cover all portions of the container body 110 that can contact the liquid therewithin. For example, the interior surface 104 can be covered by the silicone layer 105. Liquid in the body 110 contacts the silicone layer 105, not the shell 102.

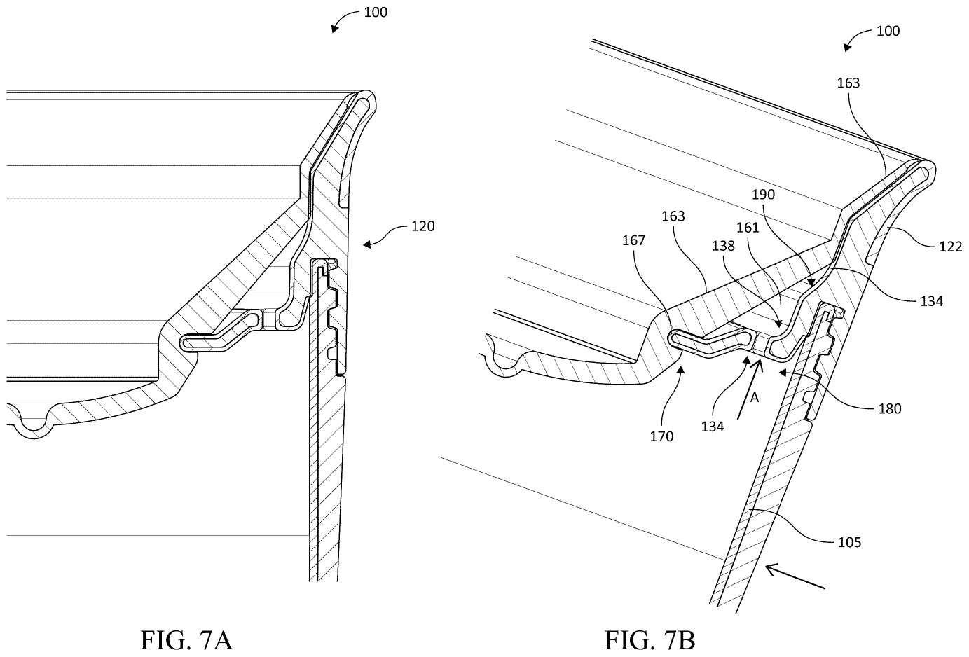

As discussed above, the drinking cup 100 includes a collar 120. The collar 120 can include a plastic base portion 152 and a silicone layer 154. The silicone layer 154 can cover all portions of the collar 120 that are in contact with the flow path of the liquid. The silicone layer 154 can cover all portions of the collar 120 that are in contact with an oral surface of the user (e.g., bottom lip edge 122 illustrated in FIG. 7B). In some embodiments, the body 110 and collar 120 are 100% overmolded. For example, the outside and inside of body 110 and collar 120 are 100% overmolded with silicone.

In some embodiments, the container body 110 and collar 120 and silicone layers are joined during injection molding. In certain embodiments, the silicone layer is over-molded to the container body 110 and collar 120 that are also injection molded. For example, the container body 110 and collar 120 include a silicone layer that is injection molded and over-molded to an interior surface 104 and base portion 152 of the drinking cup 100 that has been injection molded by a two component (2K) molding process. A preform base of the container body 110 and collar 120 (the initial molded base structure of the container body 110 and collar 120) can be molded separately in corresponding injection molds. Each mold can be configured as a 2K mold. The plastic base portion and the silicone over-mold can be formed within the same mold. In some embodiments, the plastic base portion 152 can be injection molded first before the silicone layer 154 can be applied to the surface of the plastic base portion 152 by liquid injection. The hardness of the silicone can be controlled depending on the user's need or the intended configuration. Once completed, a permanently bonded and durable seal between the hard plastic and the silicone layer is achieved. The thickness of the silicone layer 105 of the container body 110 and/or the silicone layer 154 of the collar 120 can vary. The silicone layer 105 and silicone layer 154 can be applied such that they form a generally uniform and/or controlled thickness, depending on the user's need. In certain variants, the silicone layer on the body 110 and/or collar 120 has a thickness of about: 1 mm, 1.25 mm, 1.5 mm, 2 mm, 2.5 mm, 3 mm, or otherwise. In some embodiments, a plastic core is formed in a 1K mold, then is placed another mold, then the silicone is overmolded onto the core.

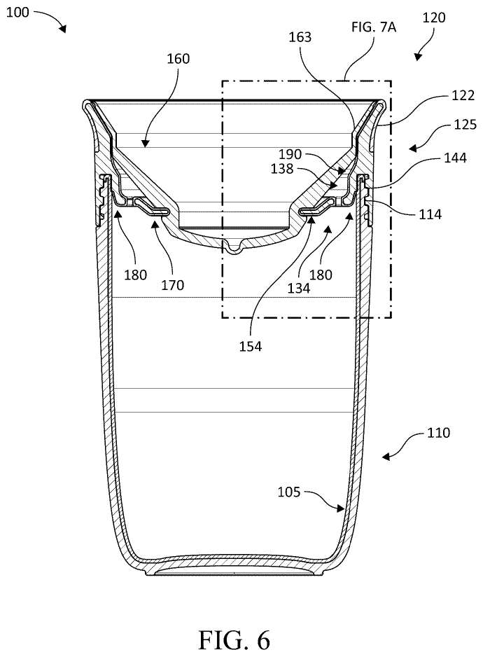

FIG. 6 illustrates a longitudinal cross section of the drinking cup 100, with the valve 160 positioned on the collar 120 and the collar positioned on the body 110. The container body 110 can mechanically couple with the valve 160 at an engagement portion 125. In some embodiments, the collar 120 includes an internal threaded portion 144 that threadably engages and/or mates with a corresponding external threaded portion 114 formed on an upper region of the container body 110. The threads of the collar 120 and the threads of the container body 110 can be complementary in pitch and profile such that relative rotation of the collar 120 with respect to the container body 110 causes axial translation of the collar 120 toward or away from the container body 110, depending on the direction of the rotation. In one example, continued clockwise rotation of the collar 120 draws the collar 120 into a seated position on the container body 110, thereby securing the collar 120 thereto. Once the collar 120 is seated and the valve 160 is positioned within the collar 120, the drinking cup 100 is sealed to inhibit unintended liquid dispensing. Advantageously, this seal (e.g., liquid tight) is achieved without the use of a separate gasket member while ensuring that liquid within the container body 110 contacts only a silicone material.

In some embodiments, the container body 110 provides a sealed assembly without the use of a separate gasket member, while allowing the liquid within the container body 110 to contact only a non-plastic and/or non-petroleum-based material, such as silicone. For example, as illustrated in FIG. 6, once the valve 160 is inserted in the collar 120, and the collar 120 is seated on the container body 110, the drinking cup 100 provides a first seal 170, a second seal 180, and a third seal 190 to inhibit unintended flow of water or other liquid out of the container body 110.

The first seal 170 can provide a sealed portion between the valve 160 and the opening 140 of the collar 120. In some embodiments, the valve 160 is formed of silicone (or includes a silicone layer), and the collar 120 includes a silicone layer 154. When the valve 160 is inserted into the collar 120 (e.g., the bulbous portion of the valve is received in the opening 140), the silicone layer of the valve directly contacts the silicone layer 154 of the collar 120 to form the first seal 170. This silicone-to-silicone interface provides a sealed portion that inhibits or prevents leakage and unintended liquid dispensing through the opening 140. Advantageously, the use of mating silicone surfaces provides a sealed portion that uses only silicone material without requiring a separate gasket component.

The second seal 180 provides a sealed portion between the container body 110 and valve 160. In some embodiments, the container body 110 includes the silicone layer 105, and the collar 120 includes the silicone layer 154. When the collar 120 is seated in the container body 110 (for example, mechanically threaded through engagement portion 125), the silicone layer 154 of the collar 120 valve directly contacts the silicone layer 105 of the container body 110 to form the second seal 178. This silicone-to-silicone interface provides a sealed portion that inhibits leakage and unintended liquid dispensing at the engagement portion 125 between the container body 110 and collar 120. Advantageously, the use of mating silicone surfaces provides a sealed portion that uses only silicone material without requiring a separate gasket component.

The third seal 190 provides a sealed portion between an upper portion of the valve 160 (e.g., the lip 163) and an upper portion of the collar 120 (e.g., the abutment surface 138). In some embodiments, the lip 163 is formed of or includes silicone, and the abutment surface 138 includes the silicone layer 154. Accordingly, when the valve 160 is inserted in the collar 120, the silicone layer 154 of the collar 120 directly contacts the silicone of the valve 160 to form a third seal 190. This silicone-to-silicone interface provides a sealed portion that inhibits leakage and unintended liquid dispensing at an upper edge of the drinking cup 100 between the collar 120 and valve 160. Advantageously, the use of mating silicone surfaces provides a sealed portion that uses only silicone material. As shown, the silicone layer 154 can extend around the lip edge 163 and/or down a portion of the outside of the cup. As such, the collar 120 can have an outer silicone section or pad (e.g., bottom lip edge 122). During use, the bottom lip of the user can be received on the outer silicone pad and/or does not contact hard plastic.

FIG. 7A illustrates a portion of the longitudinal cross section of the drinking cup 100 in a first position. The first position can be when the drinking cup 100 is in a generally vertical orientation. FIG. 7B illustrates a portion of the longitudinal cross section of the drinking cup in a second position. The second position can be when the drinking cup 100 is tilted, for example, when the user prepares to drink the liquid contained within the container body 110.

As discussed above, the drinking cup 100 includes a first seal 170 and second seal 180, which inhibit unintended leakage of liquid between the container body 110 and valve 160 and between container body 110 and collar 120. Accordingly, the liquid contained within the container body 110 is directed to flow through one or more passageways intended to direct a flow of liquid, such as the passage 134, as illustrated with arrow A. Even after passing through the passage 134, the liquid is inhibited to flow out of the drinking cup 100 through the third seal 190. If the user intends to dispense the liquid out of the drinking cup 100, the user can apply a pressure (e.g., an inward lip pressure) to displace (e.g., tilt and/or lift) the lip 163 of the valve 160 away from the abutment surface 138 of the collar 120, thereby allowing the liquid to flow out of the drinking cup 100. In certain implementations, the lip 163 can move between a first position and a second position, such as in response to pressure from a user's mouth on the lip 163 and/or the collar 120. In the first position, the lip can be sealingly engaged with (e.g., flush against, pressed against, etc.) the silicone layer of the collar 120 to provide a generally liquid-tight seal. In the second position, the lip 183 can be separated from the collar (e.g., displaced upward relative to) to enable dispensation of the liquid.

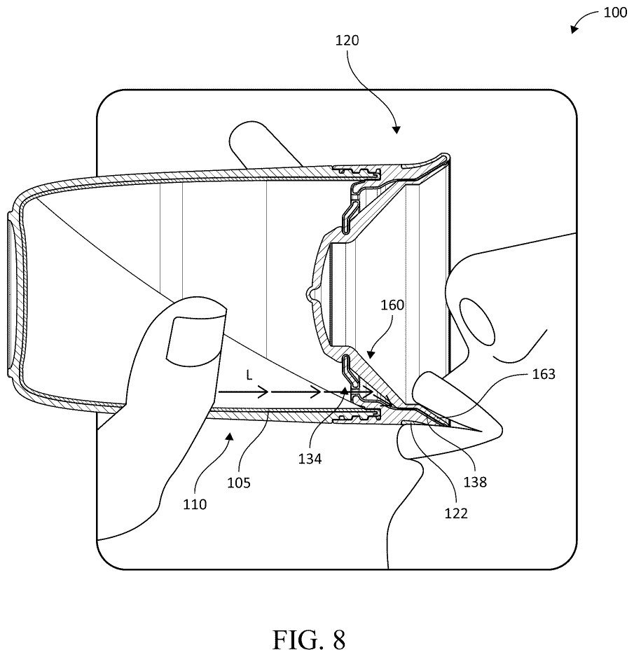

FIG. 8 illustrates a cross section of the drinking cup of FIG. 1 in use according to one aspect of the present disclosure. In use, the user's lip contacts (e.g., presses on) the lip 163 of the valve 160. Due to elasticity of the valve 160, the inward pressure from the user's lip makes the lip 163 of the valve 160 lift away from the abutment surface 138. Once the lip 163 lifts, the third seal 190 (see FIG. 6) is broken, thereby allowing the liquid to travel out of the drinking cup 100 and into the user's mouth. In some embodiments, the user applies suction to displace the lip 163 of the valve 160 from the abutment surface 138 of the collar 120. As shown, during drinking, the user's top and bottom lips can contact (e.g., exclusively) silicone or another non-plastic material, and/or the liquid flowing out of the cup 100 contacts (e.g., exclusively) silicone or another non-plastic material.

In some embodiments, the entire flow path of the liquid is configured such that the liquid contacts silicone material only or does not contact the hard plastic skeleton. For example, as illustrated in FIG. 8, the liquid in the container body 110 is surrounded by the silicone layer 105. The liquid then travels through the passage 134 and an inner surface of the collar 120, which are covered by the silicone layer 154. Further, the liquid flows between the top valve's lip edge 163 (which is made of silicone) and the collar's abutment surface 138 (which is covered by the silicone layer 154). Accordingly, the liquid travels from the container body 110 to the user's mouth by contacting exclusively silicone material and/or without making any contact with the hard plastic material.

In some embodiments, the oral surfaces of the user (e.g., an upper lip and/or a lower lip of the user) do not contact hard plastic material and are in contact with only silicone material. For example, the bottom lip edge 122 of the collar 120, which contacts the bottom lip of the user, and the lip 163, which contacts the top lip of the user, include a silicone layer. Accordingly, some embodiments of the drinking cup 100 provide a sealed leakproof drinking cup that includes only silicone contact surfaces for the liquid contained therein and the mouth of the user.

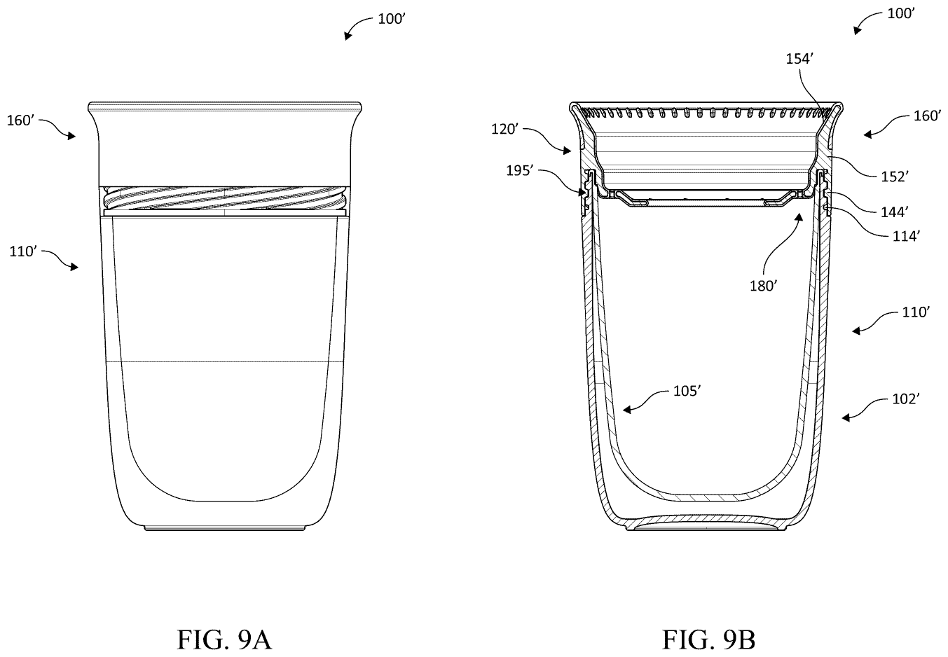

FIG. 9A and FIG. 9B illustrate a drinking cup 100′ according to another embodiment of the present disclosure. More specifically, FIG. 9A illustrates a side view of a drinking cup 100′, and FIG. 9B illustrates a longitudinal cross-sectional side view of a drinking cup 100′. The drinking cup 100′ can include any or all features of the drinking cup 100 discussed above. In some embodiments, the drinking cup 100′ includes a shell 102′. In some embodiments, the shell 102′ is a hard plastic shell. In some embodiments, the shell 102′ is connected to a ring 195′. For example, the shell 102′ can be molded to the ring 195′ to permanently connect and/or seal the shell 102′ with the ring 195′. In some embodiments, the shell 102′ is removably coupled (e.g., threaded) onto the ring 195′, such as with threads as shown. Various features of the drinking cup 100′ can utilize an over-molded plastic core that uses self-bonding silicone, similar to the drinking cup 100. For example, the plastic base portion 152′ of the collar 120′ can be covered with a silicone layer 154′.

In some embodiments, the container body 110′ includes a ring 195′ with an external threaded portion 114′ (i.e., female thread) that can engage with an internal threaded portion 144′ (i.e., male thread) of the collar 120′. The ring 195′ can be manufactured from plastic. The ring 195′ can have an outer circumferential wall that bonds with a silicone body 105′. That silicone cup body 105′ is molded such that it can bond directly to the plastic ring 195′ during the molding process. In some embodiments, the ring 195′ is over-molded to create a silicone-to-silicone seal portion 180′ between the silicone cup body 105′ and the collar 120′. Advantageously, the resulting assembly provides a seal between the silicone cup body 105′ and a collar 120′ without the need for a separate sealing gasket. Similar to the drinking cup 100, some embodiments of the drinking cup 100′ provide a sealed leakproof drinking cup that includes only silicone contact surfaces for the liquid contained therein and the mouth of the user.

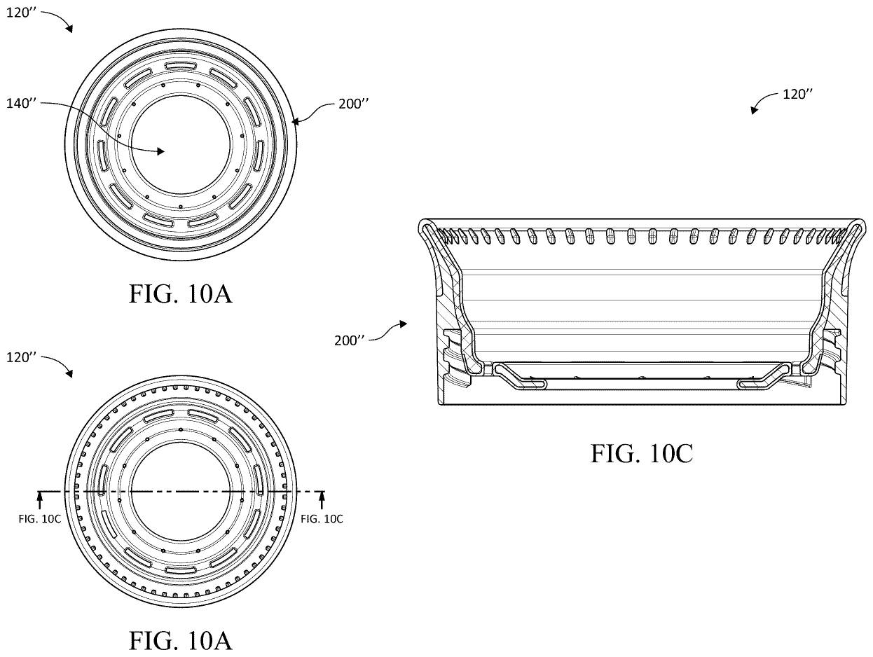

FIGS. 10A-10C illustrate a drinking cup collar 120′ according to another aspect of the present disclosure. More specifically, FIG. 10A is a bottom view of the collar 120′, FIG. 10B is a top view of the collar 120′, and FIG. 10C is a side cross-sectional view of the collar 120′. The collar can be used with the cups 100, 100′ discussed above.

In some embodiments, the drinking cup collar 120′ includes a metal (e.g., stainless steel, aluminum, etc.) collar core 200′. The collar 120′ can incorporate any or all of the features and techniques disclosed herein with respect to other embodiments of the present disclosure. For example, similar over-molding techniques can be used to over-mold the metal collar core 200′ in the collar 120′.

The metal core can provide advantages over cores made of plastic or other materials. The metal core 200′ can stiffen the collar 120′, thereby making the collar 120′ rigid. The metal core 200′ can stiffen the upwardly extending sides of the collar 120′ to help maintain a seal between the edges of the silicone valve (e.g., valve 160 in FIG. 2) and the drinking lip of the collar 120′.

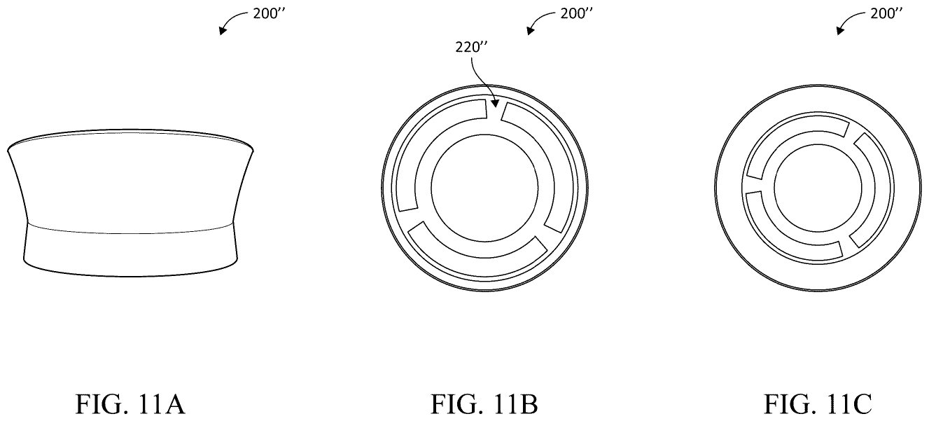

FIGS. 11A-11C illustrate an example of the metal core 200′. More specifically, FIG. 11A is a side view of the metal core 200′, FIG. 11B is the bottom view of the metal core 200′, and FIG. 11C is the top view of the metal core 200′. The metal core 200′ can stiffen the collar 120′. The metal core 200′ can include a planar portion 220′ to stiffen the portion of the collar 120′ that the valve 160 snaps into. Consequently, the collar 120′ can provide a rigid assembly, thereby reducing the likelihood of flexing when the valve (e.g., valve 160) is inserted in the opening 140′. The planar portion 220′ can enable the valve to remain securely in the drinking cup 100′.

Various embodiments of the present disclosure include providing a silicone layer over certain features of a drinking cup (e.g., portions of a collar and/or container body). It should be noted that silicone can be incorporated into said embodiments in more than one way. Some embodiments of the present disclosure include self-bonding silicone. For example, the silicone can be formulated to bond directly to certain features of the drinking cup during the molding process using a 2K mold, whereby molding the core (e.g., base portion of the collar or shell of the container body) and over-molding is performed in one mold, thereby eliminating the need to perform the molding in two separate molds. Advantageously, this technique reduces the manufacturing steps and overall production costs. In some other embodiments, over-molding is achieved using a primer-based bonding silicone technique. For example, a primer or adhesive layer can be applied first to help the silicone material bond with certain features of the drinking cup. Some embodiments of the present disclosure use self-bonding silicone for certain features of a drinking cup and primer-based bonding silicone technique for some other features. Some embodiments of the present disclosure include spray-applied silicone.

This fabrication methodology disclosed herein can be applied to other style drinking cups such as spouted, straw cups, and/or open cups. Accordingly, the cup body and/or the color of such other style drinking cups can be formed (e.g., molded) utilizing a rigid (e.g., hard plastic) skeleton and a silicone skin (e.g., self-boding), similar to the drinking cup 100, to provide a vessel in which liquid and/or the user's lips contact solely non-plastic surfaces.

Certain cups are described above in the context of a 360° sippy cup, but the present disclosure can apply to other cups and vessels too. The present technology can be applied to other types of feeding products such as bottles, mugs, travel cups, bowls, plates, and/or utensils. The techniques disclosed herein can be applied to any plastic component that requires a bonded silicone layer.

Although certain examples are described above in which the liquid contacts only silicone material and/or does not any plastic material of the cup during dispensation out of the cup, in certain variations the liquid contacts an insignificant or de minims amount of plastic material of the cup (e.g., due to manufacturing tolerances or errors, scratches or defects in the silicone layer, imperfect sealing, etc.). For example, in certain embodiments, of the total surface area of the cup that is contacted by the liquid during dispensation, the percentage that is a plastic material is less than or equal to about: 1%, 2%, 3%, or 5%. In some variants, the valve is a ring valve and/or the collar is a solid threaded collar with a central solid hub that the ring valve attaches to.

Although certain advantages of the drinking cups of the present disclosure are included herein, the present disclosure is not limited to such advantages, and the drinking cup of the present disclosure can have other advantages. For example, the drinking cups disclosed herein can have a long use life (similar to or more than traditional mono-material drinking cups), meet global food contact and baby feeding safety standards for chemical and/or mechanical functions, and/or be environmentally sustainable.

Certain terminology may be used in the description for the purpose of reference only, and thus is not intended to be limiting. For example, terms such as “front”, “rear”, “above”, “below”, “top”, “bottom”, “left”, “right”, and similar terms refer to directions in the drawings to which reference is made. Such terminology may include the words specifically mentioned above, derivatives thereof, and words of similar import. Similarly, the terms “first”, “second”, and other such numerical terms referring to structures neither imply a sequence or order unless clearly indicated by the context.

Conditional language used herein, such as, among others, “can,” “could,” “might,” “may,” “e.g.,” and the like, unless specifically stated otherwise, or otherwise understood within the context as used, is generally intended to convey that certain aspects include, while other aspects do not include, certain features, elements and/or states. Thus, such conditional language is not generally intended to imply that features, elements and/or states are in any way required for one or more aspects or that one or more aspects necessarily include logic for deciding, with or without author input or prompting, whether these features, elements and/or states are included or are to be performed in any particular aspect.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item.

The terms “approximately,” “about,” and “substantially” as used herein represent an amount close to the stated amount that still performs a desired function or achieves a desired result. For example, in some embodiments, as the context may permit, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may permit, the term “generally parallel” can refer to something that departs from exactly parallel by less than or equal to 20 degrees. As another example, in certain embodiments, as the context may permit, the term “generally perpendicular” can refer to something that departs from exactly perpendicular by less than or equal to 20 degrees.

Some embodiments have been described in connection with the accompanying drawings. The figures are drawn to scale, but such scale is not limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

Various embodiments and examples of drinking cups, and associated systems and methods, have been disclosed herein. Although the invention has been disclosed in the context of certain embodiments and examples, it will be understood by those skilled in the art that this disclosure extends beyond the specifically disclosed embodiments to other alternative embodiments and/or uses of the embodiments and certain modifications and equivalents thereof. The scope of the present disclosure is not intended to be limited by the specific disclosures of preferred embodiments in this section or elsewhere in this specification, but should be determined only by a fair reading of the claims.

The following is claimed:

1. A 360° sippy cup comprising:
a body configured to receive a liquid, the body comprising an inner surface and a rigid outer shell, the inner surface comprising silicone such that the liquid contacts only the silicone of the body;
a collar coupled with the body, the collar having a first user-contact portion, the collar comprising a rigid plastic base and a silicone layer over the rigid plastic base, the silicone layer covering an inside of the collar, wrapping around an upper lip of the collar, and extending down an outside of the collar; and
a valve sealingly disposed within the collar, the valve comprising silicone, the valve having an upper surface and a lower surface, the upper surface having a second user-contact portion, the valve having a lip configured to move relative to the collar to dispense the liquid in response to pressure from a user's mouth on the upper surface;
the cup configured such that, during dispensing of the liquid out of the cup, the liquid contacts only silicone.

2. A sippy cup, comprising:
a body configured to store a liquid, the body having a shell comprising an inner silicone layer;
a collar coupled to the body, the collar comprising a rigid core and a silicone layer over the rigid core; and
a valve having an upper surface and a lower surface, the valve connected to the collar, the valve having a lip configured to move between a first position and a second position in response to pressure from a user's mouth on the lip, wherein in the first position the lip is sealingly engaged with the silicone layer of the collar and wherein in the second position the lip is separated from the collar to enable dispensation of the liquid, and wherein during dispensation the liquid contacts only silicone during travel from the body to the user's mouth.

3. The sippy cup of claim 2, wherein the collar is threadably coupled to the body.

4. The sippy cup of claim 2, wherein the core is made from polybutylene terephthalate hard plastic.

5. The sippy cup of claim 2, wherein the silicone layer of the collar is over-molded to the core.

6. The sippy cup of claim 2, wherein the collar comprises one or more passages to enable flow of the liquid out of the body.

7. The sippy cup of claim 6, wherein the lower surface of the valve contacts the silicone layer of the collar to form a first seal.

8. The sippy cup of claim 6, wherein the silicone layer of the collar contacts the inner silicone layer of the body to form a second seal.

9. The sippy cup of claim 7, wherein the liquid is configured to flow out of the body only through the one or more passages.

10. The sippy cup of claim 2, wherein the body and the collar are coaxial such that an axis extending longitudinally through a center of the body aligns with an axis extending longitudinally through a center of the collar.

11. The sippy cup of claim 2, wherein the valve includes a lower groove configured to engage with a fastening surface of the collar.

12. The sippy cup of claim 2, wherein the valve includes an upper groove configured to engage with an indentation and an abutment surface of the collar.

13. The sippy cup of claim 2, wherein the shell of the body includes a window.

14. The sippy cup of claim 13, wherein the inner silicone layer of the body includes a clear silicone material, and a volume scale is molded into the clear silicone material to enable a user to see how much of the liquid is left in the body.

15. A method of making a drinking cup, the method comprising:
obtaining a hard plastic outer shell for a body of the drinking cup;
molding a silicone inner surface onto the hard plastic outer shell such that the silicone inner surface lines the body of the drinking cup;
obtaining a hard plastic base for a collar of the drinking cup;
molding a silicone layer onto portions of the hard plastic base of the collar that contact liquid and a mouth of a user;
obtaining a valve that includes a silicone surface;
inserting the valve in the collar; and
coupling the collar to the body.

16. The method of claim 15, wherein obtaining the valve comprises sealing the valve within the collar such that the silicone surface of the valve directly contacts the silicone layer of the collar.

17. The method of claim 15, wherein coupling the collar to the body comprises sealing the collar and the body such that the silicone layer of the collar directly contacts the silicone inner surface of the body.

18. The method of claim 15, wherein obtaining the hard plastic base comprises injection molding the hard plastic outer shell from polybutylene terephthalate.

19. The method of claim 15, wherein molding the silicone inner surface onto the hard plastic outer shell is performed using two-component injection molding process.

20. The method of claim 15, further comprising forming a window in the hard plastic outer shell and molding a clear silicone material into the window.
